(19) United States
(12) Patent Application Publication
(10) Pub. No.: US 2013/0284557 A1
(43) Pub. Date: Oct. 31, 2013

(54) VEHICLE DRIVING FORCE TRANSMISSION DEVICE

(71) Applicants: Satoru Kasuya, Nishio (JP); Masashi Kito, Anjo (JP); Yuichi Seki, Okazaki (JP); Yusuke Takahashi, Anjo (JP)

(72) Inventors: Satoru Kasuya, Nishio (JP); Masashi Kito, Anjo (JP); Yuichi Seki, Okazaki (JP); Yusuke Takahashi, Anjo (JP)

(73) Assignee: AISIN AW CO., LTD., Anjo-shi, Aichi-ken (JP)

(21) Appl. No.: 13/997,779

(22) PCT Filed: Mar. 9, 2012
(86) PCT No.: PCT/JP2012/056124

§ 371 Date: Jun. 25, 2013

(30) Foreign Application Priority Data
Mar. 17, 2011 (JP) 2011-059747

(51) Int. Cl. F16D 25/0635

(52) U.S. Cl. CPC F16D 25/0635
USPC 192/85.23

(57) ABSTRACT

Leakage oil from a hydraulic actuator operating a dry clutch is prevented from leaking into a dry space where the dry clutch is placed. A space formed by the back surface of a piston of a hydraulic actuator, a coupling plate, and a cylinder portion is sealed by a first seal portion and a second seal portion. Oil leaked from a hydraulic oil chamber through the piston is stored in the space, and is returned to a wet space in a case through an oil passage.

### INCORPORATION BY REFERENCE

The disclosure of Japanese Patent Application No. 2011-059747 filed on Mar. 17, 2011 including the specification, drawings and abstract is incorporated herein by reference in its entirety.

### BACKGROUND OF THE INVENTION

The present invention relates to a vehicle driving force transmission device that transmits power from a driving source such as an engine or a motor to wheels via a clutch and a transmission, and more particularly to the structure of a hydraulic actuator of a dry clutch that transmits power from the driving source to an input shaft of the transmission.

### DESCRIPTION OF THE RELATED ART

As hybrid drive devices using an engine and an electric motor as driving sources, those hybrid drive devices are known which couple a rotor of an electric motor to an input shaft of a transmission and have a dry clutch placed between the input shaft and an engine to start the engine by the electric motor for driving the vehicle to travel.

The dry clutch interposed between the input shaft of the transmission and the engine is placed in a non-lubricating dry space, is continuously biased to an engaged state, and is disengaged by supply of an oil pressure to the hydraulic actuator.

Conventionally, in the structure in which the hydraulic actuator is placed between the transmission and a clutch cover of the dry clutch and movement of a piston of the hydraulic actuator is transmitted to the dry clutch via a clutch arm extending through the clutch cover, a leakage oil collecting device is known which prevents leakage oil from a piston arm sliding portion of the hydraulic actuator from leaking toward the dry clutch located in the dry space, and which collects the leakage oil in the transmission (Japanese Patent Application Publication No. 2010-286112 (JP 2010-286112 A)).

In this leakage oil collecting device, the clutch cover is provided with a partition elastic member such that the partition elastic member separates the clutch arm from the dry clutch, and a cylinder housing and the clutch cover are sealed by a first seal member, so that the leakage oil from the piston arm sliding portion of the hydraulic actuator is returned into the transmission through a gap formed between the cylinder housing and the clutch cover and a first collecting oil passage.

### SUMMARY OF THE INVENTION

In the leakage oil collecting device, the partition elastic member closing a through hole portion for a piston arm prevents the leakage oil from the piston arm sliding portion from leaking into the dry space for the dry clutch. Moreover, the clutch cover as a rotary member and the cylinder housing as a stationary member are sealed by the first seal member, and the gap between the clutch cover and the cylinder housing is used as the first collecting oil passage extending from a bearing lubricating oil passage to a position downstream of the piston arm sliding portion. The leakage oil thus flows into the first collecting oil passage and is returned into the transmission.

Accordingly, this leakage oil collecting device has a large size as a space between the clutch cover and the cylinder housing that are sealed by the first seal member is required in addition to the partition elastic member. Moreover, since this leakage oil collecting device uses the bearing lubricating oil passage, locations where the leakage oil collecting device is applied are limited.

It is an object of the present invention to provide a vehicle driving force transmission device which collects leakage oil from a hydraulic actuator portion operating a dry clutch, by a small device that is compact especially in the axial direction, and which thus solves the above problems.

According to a first aspect of the present invention, a space formed by a piston back surface, a coupling member, and a cylinder portion which operate a dry clutch is sealed by a first seal portion and a second seal portion. Thus, oil leaked by sliding of a piston from a hydraulic oil chamber of a hydraulic actuator is stored in this space, and is returned to a lubricating space in a case through an oil passage. Accordingly, no leakage oil from the hydraulic actuator leaks into a dry space accommodating the dry clutch, and no dust in the dry space enters the hydraulic actuator, whereby reliability of action and operation of the dry clutch can be improved by a relatively simple device including the second seal portion on the coupling member.

According to a second aspect of the present invention, the cylinder portion is formed by annular radially outer and inner flange portions, and the coupling member is formed by a coupling plate having a bent portion extending along a radially inner surface of the radially inner flange portion. Thus, the hydraulic actuator and an operating member of the dry clutch can be placed so as to overlap each other in an axial direction, whereby an axial dimension can be reduced, and the operating portion of the dry clutch can be made compact. In particular, compactness can be improved in the axial dimension.

According to a third aspect of the present invention, the first seal portion of the piston and an inner seal of the second seal portion of the coupling member which move together are placed so as to overlap each other in the axial direction. Thus, compactness can be increased in the axial dimension.

According to a fourth aspect of the present invention, the dry clutch is a dry single-plate clutch, and the dry clutch is continuously engaged by biasing force of a spring, and is disengaged by releasing the biasing force via a release bearing by supply of a hydraulic oil pressure of the hydraulic actuator. Thus, the clutch, which is used in the state where a vehicle is driven by an internal combustion engine, and which is used for a long time, is engaged by the biasing force of the spring. Accordingly, the hydraulic oil pressure for releasing the clutch need only be supplied for a short time, whereby energy saving can be achieved.

According to a fifth aspect of the present invention, even if the present invention is applied to a hybrid drive device that includes an electric motor and that engages the dry clutch by the electric motor to start an internal combustion engine, and the dry clutch is relatively frequently operated by the hydraulic actuator, oil leakage from the hydraulic actuator into the dry space can be prevented. Thus, a relatively simple, but reliable hybrid drive device can be provided.

### BRIEF DESCRIPTION OF THE DRAWINGS

FIG. 1 is a diagram generally showing a vehicle driving force transmission device to which the present invention can be applied;

FIG. 2 is a sectional view showing an input portion of the vehicle driving force transmission device; and

FIG. 3 is an enlarged sectional view showing a dry clutch of the vehicle driving force transmission device and a hydraulic actuator that operates the dry clutch.

### DETAILED DESCRIPTION OF THE EMBODIMENTS

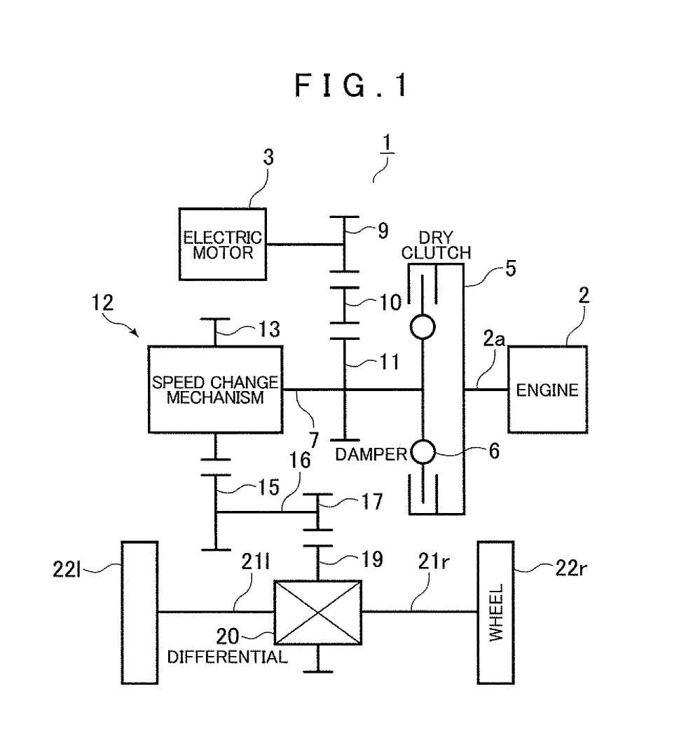

A vehicle driving force transmission device of the present invention will be described with reference to the accompanying drawings. The vehicle driving force transmission device is applied as a one motor-type hybrid drive device 1, and as shown in FIG. 1, has an internal combustion engine 2 and an electric motor 3 as driving sources. An output shaft 2a of the engine 2 is coupled to an input shaft 7 via a dry clutch 5 and a damper spring 6. A rotor of the electric motor 3 is coupled via an output gear 9 and an idler gear 10 to a gear 11 provided on the input shaft 7.

Rotation of the input shaft 7 is shifted by a speed change mechanism 12, and is transmitted to a counter drive gear 13 and also transmitted to a counter shaft 16 via a counter driven gear 15. Rotation of the counter shaft 16 is transmitted to a differential unit 20 via a gear 17 and a differential mount gear 19, and is transmitted to left and right drive wheels 22l, 22r via left and right axle shafts 21l, 21r. The speed change mechanism 12 may be any speed change mechanism like an automatic stepped speed change mechanism such as four forward speeds, six forward speeds, or eight forward speeds, a stepless speed change mechanism such as a belt type or a cone ring type, etc.

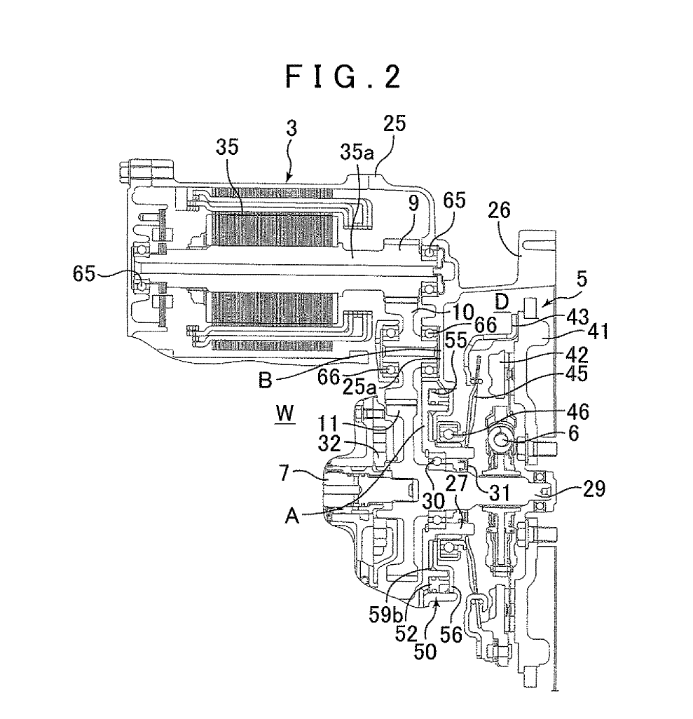

The speed change mechanism 12, the counter shaft 16, and the differential unit 20 are accommodated as a transmission in a case, and as shown in FIG. 2, the electric motor 3 is also accommodated together with the gears 9, 10, 11 in this case 25. The case 25 contains oil serving as lubricating oil and hydraulic oil, and thus forms a wet space (environment) W. A clutch housing 26 is integrally formed on the front side of the case 25. The dry clutch 5 is accommodated in the clutch housing 26, and the front end of the clutch housing 26 is fixed to the internal combustion engine 2. The clutch housing 26 forms a dry (dry, non-wet, open) space D.

The transmission in the case 25 is separated from the dry space D by a front wall 25a. A clutch shaft 29 extends through and is supported by a boss portion 27 of the front wall 25a via a bearing 30, and is sealed by an oil seal 31. The clutch shaft 29 is spline engaged with the input shaft 7 of the transmission (the mechanism 12 etc.) in the case 25. The gear 11 is formed integrally with the clutch shaft 29, and the clutch shaft 29 is coupled to an oil pump 32. The gear 9 is formed integrally with a rotor shaft 35a having the rotor 35 of the electric motor 3, and the rotor shaft 35a is rotatably supported by the case 25 via bearings 65, 65. The idler gear 10 is also rotatably supported by the case 25 via bearings 66, 66, and rotation of the rotor shaft 35a is transmitted to the input shaft 7 via the gears 9, 10, 11.

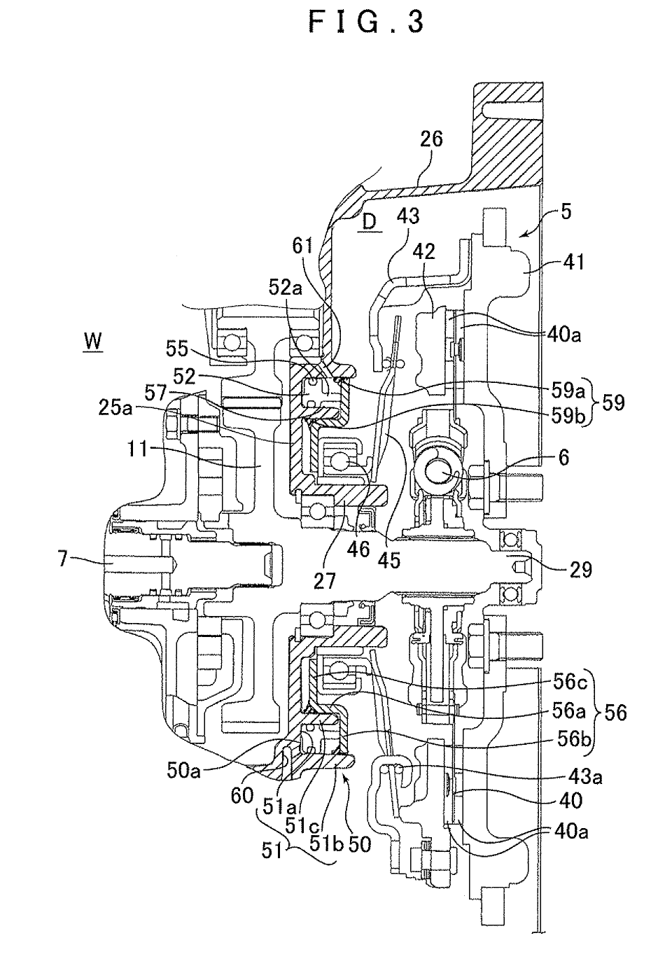

As shown in FIG. 3, the dry clutch 5 is a dry single-plate clutch having a single clutch plate 40 coupled to the clutch shaft 29 via the damper spring 6. Friction plates 40a, 40a are bonded to both sides of the clutch plate 40, and the clutch plate 40 is located between a flywheel 41 integrally fixed to the engine output shaft 2a and a pressure plate 42. A clutch cover 43 is fixed to the flywheel 41, and the pressure plate 42 is coupled to the clutch cover 43 so as to be movable together with the clutch cover 43 in the rotation direction and to be movable by a predetermined amount in the axial direction with respect to the clutch cover 43. An intermediate portion of a diaphragm spring 45 is supported by a distal end 43a of the clutch cover 43, so that the radially outer end of the diaphragm spring 45 can contact the pressure plate 42, and the radially inner end of the diaphragm spring 45 contacts a release bearing 46 as a clutch operating member. The release bearing 46 is supported by the boss 27 of the case front wall 25a so as to be rotatable and movable in the axial direction.

A hydraulic actuator 50 that operates the dry clutch 5 according to the present invention is placed radially outward of the release bearing 46 in the case front wall 25a. The hydraulic actuator 50 has a cylinder portion 51 formed in the case front wall 25a and a piston 52. The cylinder portion 51 has an annular shape formed by an annular radially outer flange portion 51b and an annular radially inner flange portion 51c which protrude from a bottom surface 51a toward the dry space D in the axial direction. The piston 52 is sealed between the flange portions 51b, 51c by a first seal portion 55 formed by an O-ring, and is slidably fitted therebetween. A hydraulic oil chamber 50a is thus formed between the piston and the bottom surface 51a of the cylinder portion.

A piston rod 52a protruding toward the dry space D is formed integrally with the piston 52, and a coupling plate 56 as a coupling member couples the distal end of the piston rod 52a to the release bearing 46. The coupling plate 56 has a bent portion 56a formed by bending an intermediate portion of the coupling plate 56 such that the intermediate portion extends in the axial direction. A radially outer side (portion) 56b of the coupling plate 56 with respect to the bent portion 56a extends in the radial direction on the dry clutch side, and contacts the distal end of the piston rod 52a. A radially inner side (portion) 56c of the coupling plate 56 with respect to the bent portion 56a extends in the radial direction on the case side, and contacts the release bearing 46 on the case side. A second seal portion 59 comprised of an elastic member such as rubber is fixed to the coupling plate 56, and is in slide contact with the cylinder portion 51 in an oil-tight manner. Being sealed by the first seal portion 55 and the second seal portion 59, a leakage oil space 57 is formed by the back surface (the rod side) of the piston 52, the coupling plate 56, and the cylinder portion 51. The piston is configured by integrally fixing the piston rod 52a to the piston 52. The rod may be formed integrally with the coupling plate so as to extend toward the back surface of the piston, and the piston and the coupling plate may be operated together.

The bent portion 56a of the coupling plate 56 extends in the axial direction along the inner peripheral surface of the radially inner flange portion 51e of the cylinder portion 51. The second seal portion 59 is formed by an outer seal 59a fixedly attached to the outer peripheral portion of the radially outer portion 56b of the coupling plate, and an inner seal 59b fixedly attached near the radially inner portion 56c of the coupling plate 56 with respect to the bent portion 56a. The outer seal 59a closely contacts the inner peripheral surface of the radially outer flange portion 51b of the cylinder portion, and the inner seal 59b closely contacts the radially inner surface of the radially inner flange portion 51c of the cylinder portion.

The hydraulic oil chamber 50a of the hydraulic actuator 50 communicates with a valve via an oil passage 60 formed in the case 25, and a hydraulic oil pressure is supplied to the hydraulic oil chamber 50a as appropriate. The leakage oil space 57 communicates with the wet space W accommodating the transmission in the case 25, through a leakage oil collecting oil passage 61 formed so as to extend through the case front wall 25a. As FIGS. 2 and 3 are developed views, the leakage oil collecting oil passage 61 is shown to be located above the leakage oil space 57. However, the oil passage 61 is preferably located below the space 57.

As shown in FIG. 2, the case front wall 25a is structured so that the hydraulic actuator 50 and a portion A located inward of the hydraulic actuator 50 are recessed toward the transmission with respect to a portion B on which the bearings 65, 66 supporting the rotor shaft 35a and the idler gear 10 are mounted. The space in the axial direction for the hydraulic actuator 50, the coupling plate 56, and the release bearing 46 is thus reduced. The hydraulic actuator 50 and the release bearing 46 are placed so as to partially overlap each other in the axial direction as viewed in the radial direction, whereby the axial dimension is reduced. Moreover, the first seal portion 55 and the inner seal 59b of the second seal portion which move together are placed so as to overlap each other in the axial direction, whereby the axial dimension is reduced.

Since the hybrid drive device 1 is configured as described above, the vehicle is driven by the electric motor 3 during starting of the vehicle and EV driving. In this state, a predetermined operation pressure is supplied to the hydraulic oil chamber 50a of the hydraulic actuator 50 via the oil passage 60, and the piston 52 and the piston rod 52a are extended. Thus, the release bearing 46 is moved to the right in FIGS. 2 and 3 against the biasing force of the diaphragm spring 45 via the coupling plate 56 contacting the piston rod 52a, the distal end of the diaphragm spring 45 is separated from the pressure plate 42, and the dry clutch 5 is disengaged. The internal combustion engine 2 is in the stopped state, and rotation of the rotor 35 of the electric motor 3 is transmitted to the input shaft 7 via the gears 9, 10, 11, is shifted as appropriate by the speed change mechanism 12, and is transmitted to the left and right driving wheels 22l, 22r via the counter shaft 16 and the differential unit 20.

When the vehicle reaches a predetermined speed, and when a required driving force is not supplied only by the electric motor 3, the internal combustion engine 2 is started by the electric motor 3. That is, a predetermined oil pressure in the hydraulic oil chamber 50a of the hydraulic actuator 50 is released (0 pressure), and the piston 52 and the piston rod 52a are compressed to move the release bearing 46 to the left in FIGS. 2 and 3 according to the biasing force of the diaphragm spring 45 via the coupling plate 56. Thus, the radially outer end of the diaphragm spring 45 contacts the pressure plate 42 by using the distal end 43a of the clutch cover 43 as a fulcrum, and the biasing force of the diaphragm spring 45 is applied to the pressure plate 42, whereby the clutch plate 40 is held between the pressure plate 42 and the flywheel 41, and the dry clutch 5 is engaged.

Thus, the torque of the electric motor 3 is transferred to the clutch shaft 29 via the gears 9, 10, 11, and is transferred to the engine output shaft 2a via the dry clutch 5 in the engaged state, whereby the internal combustion engine 2 is started as an ignition coil is switched on. At this time, the output torque of an output portion (20) of the automatic transmission varies due to increased load resulting from starting of the engine and engine torque input after starting of the internal combustion engine, and the electric motor 3 controls its output so as to smooth the variation of the output portion of the automatic transmission. When the internal combustion engine 2 is started, power of the internal combustion engine is transmitted to the input shaft 7 via the dry clutch 5 and the clutch shaft 29, is shifted as appropriate by the speed change mechanism 12, and is transmitted to the left and right driving wheels 22l, 22r via the counter shaft 16 and the differential unit 20. At this time, the electric motor 3 idles with no load, is driven so as to assist the power of the engine 2, or regenerates electric power to charge a battery.

In order to operate the dry clutch 5, the hydraulic oil pressure is supplied to or discharged from the hydraulic oil chamber 50a of the hydraulic actuator 50 so that the piston 52 slides in the cylinder portion 51. As the piston 52 thus slides in the cylinder portion 51, oil leaks through the first seal portion 55 formed by the O-ring, and is stored in the leakage oil space 57. As the coupling plate 56 contacts the distal end of the piston rod 52a and the plate 56 moves together with the piston 52, the space 57 has the same capacity regardless of movement of the piston, and is sealed by the second seal portion 59, so that no leakage oil leaks out of the space 57. The leakage oil stored in the space 57 is collected by the wet space W in the case 25a through the oil passage 61. Thus, no oil leaks from the hydraulic actuator 50 into the dry space D accommodating the dry clutch 5, and no dust etc. enters the hydraulic oil chamber 50a of the hydraulic actuator 50 from the dry space D.

The above embodiment is described with respect to an example in which the present invention is applied to a hybrid drive device as a vehicle driving force transmission device. However, the present invention is not limited to this, and is applicable to various other vehicle driving force transmission devices such as, e.g., a driving force transmission device having an internal combustion engine using a dry clutch as a starting clutch. Although the dry clutch 5 is a single-plate clutch in the above embodiment, the dry clutch 5 may be a multi-plate clutch.

The present invention is used for vehicle drive devices including a dry clutch placed in a dry space and a transmission accommodated in a wet environment.

1-5. (canceled)

6. A vehicle driving force transmission device, comprising: a dry clutch that is placed in a dry space and permits and blocks power transmission between an engine output shaft and an input shaft of a transmission, the transmission being accommodated in a wet environment in a case containing oil and shifting rotation of the input shaft to output the shifted rotation to an output portion coupled to a driving wheel, wherein
a hydraulic actuator that operates the dry clutch is placed at such a position of the case that faces the dry space,
the hydraulic actuator has a cylinder portion formed in the case, a piston slidably fitted and inserted in the cylinder portion in an oil-tight manner by a first seal portion and forming a hydraulic oil chamber between the piston and a bottom surface of the cylinder portion, and a coupling member contacting the piston and pressing an operating member of the dry clutch,
the coupling member has a second seal portion sealing the coupling member and the cylinder portion, and
a space formed by a back surface of the piston, the coupling member, and the cylinder portion and sealed by the first seal portion and the second seal portion communicates with the transmission through an oil passage communicating with the case, so that the oil leaked into the space through the piston is returned into the case of the transmission through the oil passage.

7. The vehicle driving force transmission device according to claim 6, wherein
the cylinder portion is formed by the bottom surface, an annular radially outer flange portion, and an annular radially inner flange portion,
the coupling member is formed by a coupling plate having a bent portion extending along a radially inner surface of the radially inner flange portion, and
the second seal portion is formed by an outer seal that is fixed to a radially outer end of the coupling plate to seal the radially outer end of the coupling plate and a radially inner surface of the radially outer flange portion, and an inner seal that is fixed to the bent portion of the coupling plate to seal the bent portion of the coupling plate and the radially inner surface of the radially inner flange portion.

8. The vehicle driving force transmission device according to claim 6, wherein
the first seal portion and the inner seal of the second seal portion are placed so as to overlap each other in an axial direction as viewed in a radial direction.

9. The vehicle driving force transmission device according to claim 7, wherein
the first seal portion and the inner seal of the second seal portion are placed so as to overlap each other in an axial direction as viewed in a radial direction.

10. The vehicle driving force transmission device according to claim 7, wherein
the dry clutch is a dry single-plate clutch, and the dry clutch is engaged by biasing a clutch plate coupled to the input shaft toward the engine output shaft by a spring, and is disengaged by releasing the biasing force by a release bearing as the operating member, and
a radially outer side of the coupling plate with respect to the bent portion extends in the radial direction on a dry clutch side and contacts a distal end of a piston rod formed integrally with the piston, and a radially inner side of the coupling plate with respect to the bent portion extends in the radial direction on a case side, and contacts the release bearing on the case side.

11. The vehicle driving force transmission device according to claim 8, wherein
the dry clutch is a dry single-plate clutch, and the dry clutch is engaged by biasing a clutch plate coupled to the input shaft toward the engine output shaft by a spring, and is disengaged by releasing the biasing force by a release bearing as the operating member, and
a radially outer side of the coupling plate with respect to the bent portion extends in the radial direction on a dry clutch side and contacts a distal end of a piston rod formed integrally with the piston, and a radially inner side of the coupling plate with respect to the bent portion extends in the radial direction on a case side, and contacts the release bearing on the case side.

12. The vehicle driving force transmission device according to claim 9, wherein
the dry clutch is a dry single-plate clutch, and the dry clutch is engaged by biasing a clutch plate coupled to the input shaft toward the engine output shaft by a spring, and is disengaged by releasing the biasing force by a release bearing as the operating member, and
a radially outer side of the coupling plate with respect to the bent portion extends in the radial direction on a dry clutch side and contacts a distal end of a piston rod formed integrally with the piston, and a radially inner side of the coupling plate with respect to the bent portion extends in the radial direction on a case side, and contacts the release bearing on the case side.

13. The vehicle driving force transmission device according to claim 6, further comprising:
an electric motor, wherein
a rotor of the electric motor operates together with the input shaft of the transmission.
